(19) United States
(12) Patent Application Publication
(10) Pub. No.: US 2014/0220981 A1
(43) Pub. Date: Aug. 7, 2014

(54) Enhancement Procedure of Suspending and Resuming UE Data in Mobile Communication Networks

(71) Applicant: MEDIATDK, INC., Hsinchu (TW)

(72) Inventors: Yu-Syuan Jheng, Taipei City (TW); Yuanyuan Zhang, Beijing (CN); I-Kang Fu, Taipei City (TW)

(73) Assignee: MEDIATDK, INC., Hsinchu (TW)

(21) Appl. No.: 14/251,884

(22) Filed: Apr. 14, 2014

Related U.S. Application Data
(63) Continuation of application No. PCT/CN2013/078037, filed on Jun. 26, 2013.

(30) Foreign Application Priority Data
Jun. 27, 2012 (CN) CN201210216246.3

(51) Int. Cl. H04W 72/02; H04W 36/00; H04W 88/06; H04W 76/06

(52) U.S. Cl. CPC H04W 72/02; H04W 76/06; H04W 36/0011; H04W 88/06
USPC 455/437; 455/452.1; 455/552.1

(57) ABSTRACT

A method for UE to indicate its upcoming transceiver operation status to network and help network to avoid inefficient radio resource schedule for better network efficiency is proposed. The proposed method also helps network to manage the connections for user applications to prevent unnecessary disruption due to short-term radio link disconnection. In one embodiment, the UE is a dual SIM dual standby (DSDS) UE. The UE first establishes an RRC connection and starts data transmission. Upon detecting a suspension event, the UE sends a signaling connection release indication (SCRI) with a new cause for “UE requested PS data suspension”. The SCRI may further include a suspension reason and a suspension period. When the network receives the SCRI, it will interpret that the UE may not be able to receive its downlink signal during the upcoming period and may prevent schedule radio resource for the UE.

### CROSS REFERENCE TO RELATED APPLICATIONS

This application is filed under 35 U.S.C. §111(a) and is based on and hereby claims priority under 35 U.S.C. §120 and §365(c) from International Application No. PCT/CN2013/078037, with an international filing date of Jun. 26, 2013, which in turn claims priority from Chinese Application No. 201210216246.3, filed on Jun. 27, 2012. This application is a continuation of International Application No. PCT/CN2013/078037, which claims priority from Chinese Application No. 201210216246.3. International Application No. PCT/CN2013/078037 is pending as of the filing date of this application, and the United States is a designated state in International Application No. PCT/CN2013/078037. This application claims the benefit under 35 U.S.C. §119 from Chinese Application No. 201210216246.3. The disclosure of each of the foregoing documents is incorporated herein by reference.

### TECHNICAL FIELD

The disclosed embodiments relate generally to mobile communication networks, and, more particularly, to UE enhancement for enhanced protocols for suspending UE data and resuming data transmission.

### BACKGROUND

Dual-SIM Dual-Standby (DSDS) is a very popular feature in smart phone markets today, especially in developing countries such as China and India. Many mobile phone users have multiple SIM cards for various purposes—having different phone numbers for different uses (e.g., one for business and one for personal), saving roaming fee, compensating non-contiguous network coverage, and sharing one device for multiple family members. With DSDS feature, mobile phone users can use single device to enjoy multiple SIM services. DSDS UE (User Equipment) can generally be categorized into two types. A first type is called Single Talk, where two baseband modules share the same RF module. Single Talk device has low cost and no RF coexistence interference. However, Single Talk requires complex implementation to support Dual-Standby. Single Talk only supports one voice call, and requires gap to monitor paging signals. A second type is called Dual Talk, where two baseband modules utilize tow individual RF modules. Dual Talk only requires simple implementation to support dual standby and can support voice calls over both SIM cards simultaneously. However, Dual Talk device has high cost and RF coexistence interference.

Under certain circumstances, UE may not be able to continue the active data connection and would like to request data suspension for a certain period. For example, when channel quality is suddenly degraded, when battery being exhausted, or when UE could standby in multiple access networks with shared RF resources intends to temporarily switch access from one access network to another. In current UMTS network, it is difficult for the network to learn such behavior initiated by UE. UE may have no choice but perform local release to end the connection, which may result in the problem that the network does not know UE has ended the connection and keeps trying to send data to UE. Consequently, the network capacity may be degraded due to useless transmission and the network may consider radio link failure. As a result, the network may hold the radio resource for a short time and wait for the UE's reestablishment. If the UE had entirely released the connection base on local decision, the reestablishment will not happen and hence result in unnecessary waste on network resources.

The above problems may be common to DSDS devices with shared RF resources (e.g., Single Talk). A DSDS UE may want to access the second network registered by the second SIM card whiling having active connection with the first network registered by the first SIM card. The UE may have difficulty to keep simultaneous radio connections with two different networks due to the limitation on RF resources and may directly release the radio connection from the first network in order to access the second network. This will result in the data connection with the first network be suspended, where the data connection may not able to be resumed when UE switch back to the first network after finishing the access to the second network. This is because the original data connection in the first network may be timed out due to the configuration by application, which is managed by the application server (e.g. video streaming) and out of radio access network (RAN) control. If the session control timer managed by application server is expired during the suspension of the first network access, the application server may consider the connection be disconnected and will not resume the suspended data connection even if the UE retries after radio connection is resumed. Then the UE may need to initiate a new data connection to request the previous data again. Such behavior will result in increase of signaling overhead and degrade user experience due to longer application resume processing time.

This problem may become more serious because more and more smart handheld devices (e.g. smart phone) will be equipped with multiple radio transceivers and possibly support multiple SIM cards with shared RF resources. It will be important to develop a solution to coordinate UE and network behavior in order to minimize the impact to network performance.

### SUMMARY

A method for UE to indicate its upcoming transceiver operation status to network and help network to avoid inefficient radio resource schedule for better network efficiency is proposed. The proposed method also helps network to manage the connections for user applications to prevent unnecessary disruption due to short-term radio link disconnection.

The method proposes that UE sends an indication to network when a suspension event is received to trigger the UE to switch the RF resources away from receiving signal from one registered network temporarily. The suspension event may include UE needs to receive signal from another registered network, UE battery or other hardware status is lower than a predefined threshold, UE received signal quality is extremely low, UE is in high-speed mobility, or UE packet loss and data error rate are high, etc. The proposed indication may further contain a suspension period to inform the network that the UE may not be able to receive its downlink signal or transmit its uplink signal in this upcoming period. After this suspension period, or when one or more resume events are received, the UE may determine to switch the RF resource back to the original registered network. The resume event may include UE determines to continue previous active PS data connection in the original registered network, UE battery or other hardware status is recovered, or UE is not in high-speed mobility anymore, etc. This invention in addition proposes a resume method for the UE to resume normal operation and keeping communicating with the network.

In one embodiment, the UE is a dual SIM dual standby (DSDS) UE in a UMTS network. The UE establishes an RRC connection in a first network registered by a first SIM. Upon detecting a suspension event (e.g., to receive signal from a second network registered by a second SIM), the UE sends an enhanced signaling for UE requested PS data suspension. For example, the UE sends a signaling connection release indication (SCRI) with a new cause for “UE requested PS data suspension”. The SCRI may further include a suspension reason and a suspension period. When the UMTS network receives the SCRI, it will interpret that the UE may not be able to receive its downlink signal during the upcoming period and may prevent schedule radio resource for the UE.

In one embodiment, the network initiates a state transition to move UE to CELL_PCH or URA_PCH state and keep the RRC connection until the UE reselect back to the network again. The benefit to move UE into CELL_PCH or URA_PCH state is that the UE can directly resume the RRC connection by initiating cell update procedure instead of reestablishing the RRC connection. A new cell update cause of “Resume PS data” is proposed. By receiving the cell update with the “Resume PS data” cause, the network understands that the UE is requesting for continuing previous data operation. The network could reply a cell update confirm message and then initiate a radio bearer control procedure as required.

Other embodiments and advantages are described in the detailed description below. This summary does not purport to define the invention. The invention is defined by the claims.

### BRIEF DESCRIPTION OF THE DRAWINGS

FIG. 1 illustrates a user equipment (UE) having dual SIM card dual standby (DSDS) feature in accordance with one novel aspect.

FIG. 2 is a simplified block diagram of a UE having DSDS feature in accordance with one novel aspect.

FIG. 3 illustrates an example of signaling connection release indication (SCRI) information element (IE) and cell update IE.

FIG. 4 illustrates one embodiment of UE sending SCRI to network.

FIG. 5 illustrates an example of UE being in different states before/after sending SCRI.

FIG. 6 illustrates one embodiment of UE resuming a connection via cell update procedure.

FIG. 7 illustrates one embodiment of UE autonomously release RRC connection upon timer expiry.

FIG. 8 illustrates one embodiment of UE force releasing an RRC connection.

FIG. 9 is a flow chart of a method of suspending and resuming UE data in accordance with one novel aspect.

### DETAILED DESCRIPTION

Reference will now be made in detail to some embodiments of the invention, examples of which are illustrated in the accompanying drawings.

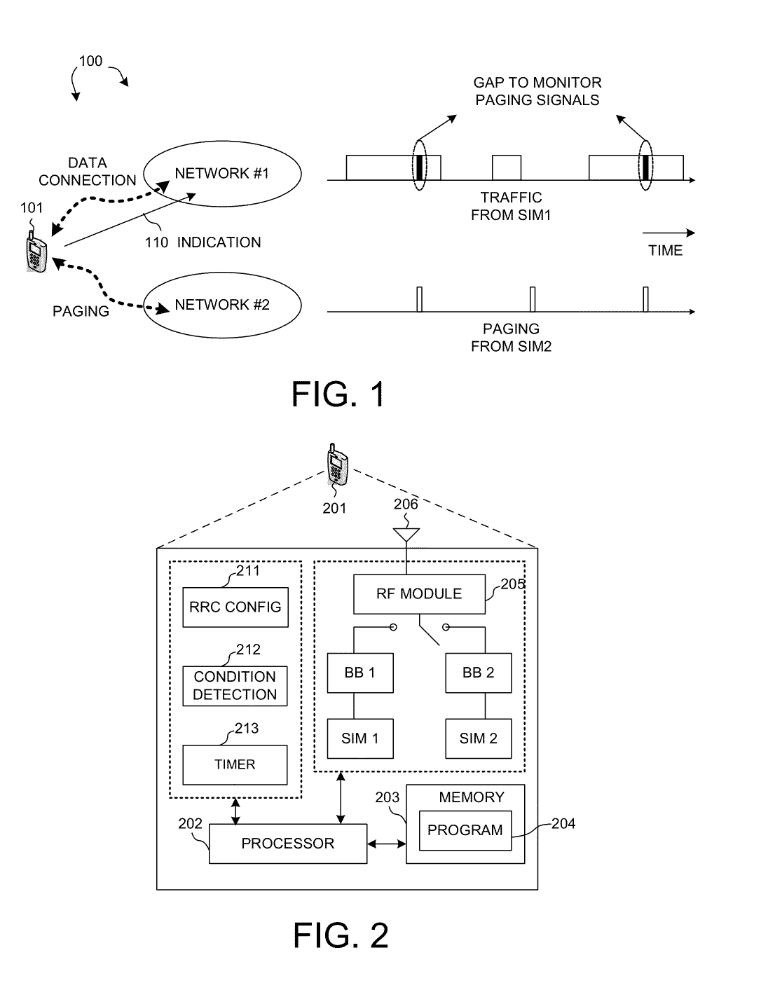

FIG. 1 illustrates a user equipment (UE) 101 having dual SIM card dual standby (DSDS) feature in a mobile communication system 100 in accordance with one novel aspect. Mobile communication system 100 comprises UE 101 and a first network #1 and a second network #2. UE 101 supports DSDS feature such that multiple SIM cards can be used to access multiple networks, e.g., SIM1 used to access network #1 and SIM2 used to access network #2. In the example of FIG. 1, UE 101 is a Single Talk UE with DSDS feature, where two baseband modules share the same RF module. Single Talk device has low cost and no RF coexistence interference. However, Single Talk requires complex implementation to support Dual-Standby. Single Talk UE only supports one voice call, and requires gap to monitor paging signals.

As illustrated in FIG. 1, UE 101 establishes an active data connection with Network #1 registered by SIM1. UE 101 transmits and/or receives ongoing data traffic over the data connection. In addition, UE 101 also monitors paging signals or system information over Network #2 registered by SIM2. If UE 101 receives actual paging over Network #2, UE 101 may have difficulty to keep simultaneous radio connections with two different networks due to the limitation on RF resources and may directly release the radio connection from the first network in order to access the second network. There are several problems associated with such scenario. First, Network #1 does not know UE 101 needs to monitor the paging or system information over Network #2. Second, if UE 101 autonomously switch RF resource for SIM2 network signal reception, it will directly result in failure reception of the data from SIM1 network. Third, eNodeB radio resource control (e.g., link adaptation) algorithms may be sensitive to the unexpected gaps and take proactive actions.

In one novel aspect, UE 101 indicates upcoming gaps due to DSDS operation by sending an indication 110 to Network #1 when the UE monitors radio signals or performs periodic location update to Network #2 whiling having active PS data connection with Network #1. For example, UE 101 sends the indicator with “UE requested PS data suspension” before switching the RF resources from Network #1 to Network #2. Upon receiving indication 110, eNodeB in Network #1 can avoid radio resource allocation to the DSDS UE and allocate the reserved resources to other UEs more efficiently. Furthermore, eNodeB can prevent error interpretation due to the unexpected gap for DSDS. UE 101 may also indicates its DSDS capability to the network. As a result, eNodeB can be less sensitive to (or ignore) the unexpected gap generated by DSDS UE and thereby minimizing signaling overhead.

FIG. 2 is a simplified block diagram of a UE 201 having DSDS feature in accordance with one novel aspect. UE 201 comprises RF module 205, coupled with antenna 206, receives RF signals from antenna 206, converts them to baseband signals, and sends them to processor 202. RF module 205 also converts received baseband signals from processor 202, converts them to RF signals, and sends out to antenna 206. Processor 202 processes the received baseband signals and invokes different functional modules to perform features in the UE. Memory 203 stores program instructions and data 204 to control the operations of the UE. UE 201 comprises two SIM cards, SIM1 and SIM2, to support DSDS feature, where SIM1 and SIM2 are coupled to their corresponding baseband modules BB1 and BB2 respectively. UE 201 is a Single Talk UE, where BB1 and BB2 share the same RF module 205 (e.g., RF transceiver, RF filter, etc.). By sharing the same RF module, UE 201 has low cost and no RF coexistence interference. However, UE 201 only supports one voice call. If SIM1 has voice call, then SIM2 cannot have any MT/MO call. UE 201 also requires gap to monitor paging signals.

FIG. 2 further illustrates three functional modules 211 to 213 in the UE that carry out embodiments of the current invention. The functional modules may be implemented by hardware, firmware, software, or any combination thereof. RRC configuration module 211 manages radio resource control (RRC) layer configuration and RRC connection establishment. Condition detection module 212 detects various triggering conditions that trigger the suspension or resuming of an ongoing RRC data connection. For example, when a UE detects certain conditions while having ongoing packet switch (PS) data, the UE sends out a signaling connection release indication (SCRI) for UE requested PS suspension. Similarly, when a UE determines to resume the previous active PS data transmission upon detecting certain conditions, the UE initiates a resume procedure such as an RRC cell update procedure. Timer 213 starts timers associated with the suspension or resuming of the RRC data connection.

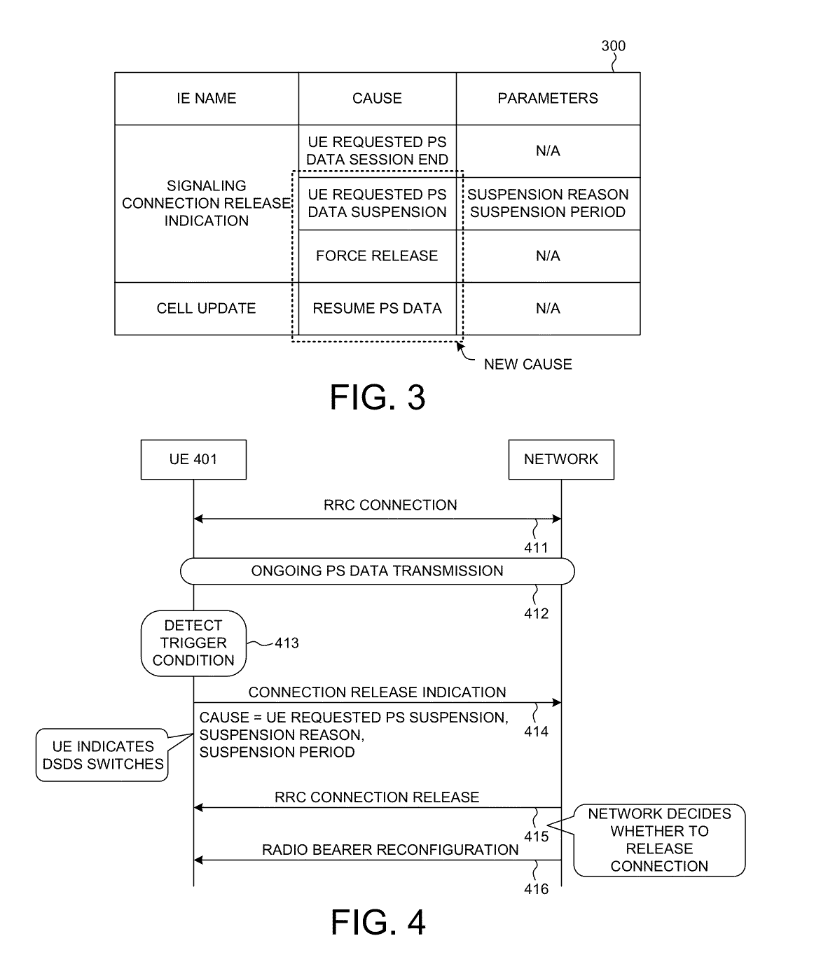

FIG. 3 illustrates an example of a signaling connection release indication (SCRI) information element (IE) and an example of a cell update IE. The original SCRI procedure defined in 3GPP Rel-8 specification is for fast dormancy. The SCRI IE is used by the UE to indicate to the UMTS network that one of its signaling connections has been released or to request the UMTS network to initiate a state transition to a battery efficient RRC state. As depicted by table 300, the associated cause of the SCRI for fast dormancy is UE requested PS data session end. Without the SCRI, it may take up to ten minutes for the UMTS network to decide whether to release the RRC connection. If the UE is not able to release the RRC connection quick enough, the UE may have to perform local release, which is not a desirable behavior. Therefore, SCRI is specifically designed for enabling fast dormancy. Upon receiving the SCRI, the network simply releases the RRC connection quickly or initiates a state transition to move the UE to a battery efficient RRC state.

In accordance with embodiments of the present invention, the traditional SCRI procedure is enhanced and is used to temporality suspend an ongoing RRC data connection and/or to resume temporarily suspended RRC data connection. As depicted by table 300, a new cause of such SCRI is referred to as “UE requested PS data suspension”. The SCRI may also comprise parameters including suspension reason and suspension period. Upon receiving the SCRI with the “UE requested PS data suspension” cause, the network decides whether to release the RRC connection based on the suspension reason, suspension period, and/or other information. For example, the network may decide to temporality send UE from CELL_FACH or CELL_DCH state to CELL_PCH or URA_PCH state by reconfiguring radio bearer. Another new cause/flag of the SCRI is force release. Upon receiving the SCRI with force release, the network releases the RRC connection directly without attempt to initiate any other procedures.

In addition to suspending PS data transmission, cell update procedure is used to resume the previously suspended PS data transmission. As depicted by table 300, a new cause of cell update is referred to as “Resume PS data”. Upon receiving cell update IE with “Resume PS data” cause, the network reconfigures radio bearer and initiates state transmission for the UE to move from CELL_PCH or URA_PCH state back to CELL_FACH or CELL_DCH state. Cell update procedure saves signaling overhead as compared to reestablish the RRC connection.

FIG. 4 illustrates one embodiment of a user equipment UE 401 sending SCRI to network for UE requested PS suspension. In the example of FIG. 4, UE 401 may be a DSDS UE having two SIM cards (SIM1 and SIM2) for accessing multiple networks. In step 411, UE 401 establishes an RRC connection with a network. For example, the network is a first network registered by SIM1. In step 412, UE 401 maintains ongoing PS data transmission with the network. In step 413, UE 401 detects one or more trigger conditions to suspend the data transmission. For DSDS UE, the trigger condition is based on upcoming activity for the UE to access a second network registered by SIM2. The upcoming activity may be the UE needs to switch the RF resources away from the first network and to monitor paging from the second network. The upcoming activity may be the UE needs to switch the RF resources away from the first network and to access the second network. For other non-DSDS UE, the trigger condition is based on comparison of a measurement result of radio signal quality, an error probability of downlink data, a UE mobility level, or a UE battery level below a corresponding threshold.

After detecting a trigger condition, in step 414, UE 401 sends a signaling connection release indication (SCRI) IE to the network. The SCRI comprises a cause of UE requested PS suspension. Upon receiving the SCRI, the network decides whether to release the RRC connection. If the network decides to release the RRC connection, in step 415, the network sends a RRC connection release message to UE 401 to release the RRC connection. On the other hand, if the network decides not to release the RRC connection, then in step 415, the network performs radio bearer reconfiguration for UE 401. For example, the network could initiate state transition to move UE 401 from CELL_DCH state to CELL_PCH or URA_PCH state until UE 401 reselects back to the network again.

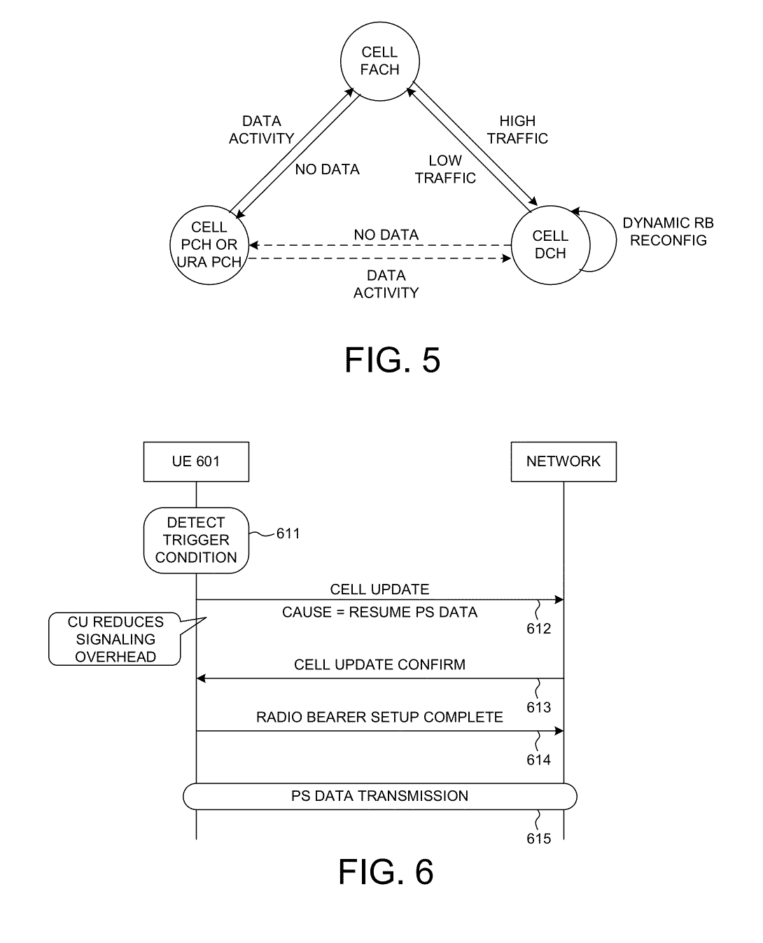

FIG. 5 illustrates an example of UE being in different states before/after sending the SCRI IE. For UTRA systems, a UE can have different RRC states as defined by the specification. In CELL_DCH state, dedicated traffic and control is carried over DCH for data transmission of large amount of data. Circuit-switched (CS) data only uses CELL_DCH for transmission. In CELL_FACH state, dedicated traffic and control is carried over RACH or FACH for data transmission of small amount of data. In CELL_PCH state, no air interface resources are required under dormant RB. The UE receives paging on cell basis rather than standard routing area (RA). UTRA PCH state is similar to CELL_PCH state except that paging is received in UTRAN Routing Area (URA), which is usually in the order of ten cells. As depicted by FIG. 5, a UE stays in CELL_DCH state with large amount of data and dynamic RB reconfiguration. If the UE has low traffic, then the UE is moved to CELL_FACH state. If the UE had no data activity, then the UE is moved to CELL_PCH or URA_PCH state, which is based on network configuration. Similarly, in CELL_FACH state, the UE moves to CELL_DCH state when it has high traffic, and moves to CELL_PCH or URA_PCH state when it has no data activity. Finally, in CELL_PCH or URA_PCH state, the UE moves to CELL_FACH or CELL_DCH state when the UE starts to have data activity.

Referring back to FIG. 4, when UE 401 sends the SCRI to the network in CELL_DCH state, instead of releasing the RRC connection, the network may decide to move the UE from CELL_DCH state to CELL_PCH or URA_PCH state. In one advantageous aspect, the SCRI also comprises a suspension reason and a suspension period to assist the network to make corresponding decision. The suspension reason may include poor signal quality, high error rate, high UE mobility, low battery level, and/or DSDS operation. The suspension period may include a predefined or negotiated duration for suspension, or a level of suspension (e.g., temporary, short-term, long-term). The network decision on whether to release the RRC connection may be based on the UE provided suspension reason, suspension period, and/or some other additional information. If the network decides not to release the RRC connection, later on, when UE 401 determines to resume the suspended data transmission, UE 401 may initiate a cell update procedure. The cell update procedure reduces signaling overhead as compared to reestablishing the RRC connection.

FIG. 6 illustrates one embodiment of UE resuming RRC connection via cell update procedure. In step 611, UE 601 detects one or more trigger conditions to resume the previously suspended RRC connection. In one example, the trigger condition may include a measurement result of radio signal quality, an error probability of downlink data, a UE mobility level, or a UE battery level is above a corresponding threshold. In another example, UE 601 is a DSDS UE having two SIM cards (SIM1 and SIM2). UE 601 first access the network registered by SIM1 and establishes a RRC connection for data transmission. Later, UE 601 may want to access another network registered by SIM2 or simply monitor paging from another network. UE 601 then switches RF resources away from the network and suspends the RRC connection. Under such scenario, the trigger condition may be UE 601 determines to switch RF resources back to the original registered network of the previous active SIM1, and to continue the previous active PS data communication. In step 612, UE 601 sends a cell update IE to the network. The cell update IE comprises a cause of Resume PS data. In step 613, the network sends a cell update confirm message back to UE 601. In step 614, UE 601 sends a radio bearer setup complete message to the network to resume the RRC connection. Finally, in step 615, UE 601 resumes the suspended PS data transmission.

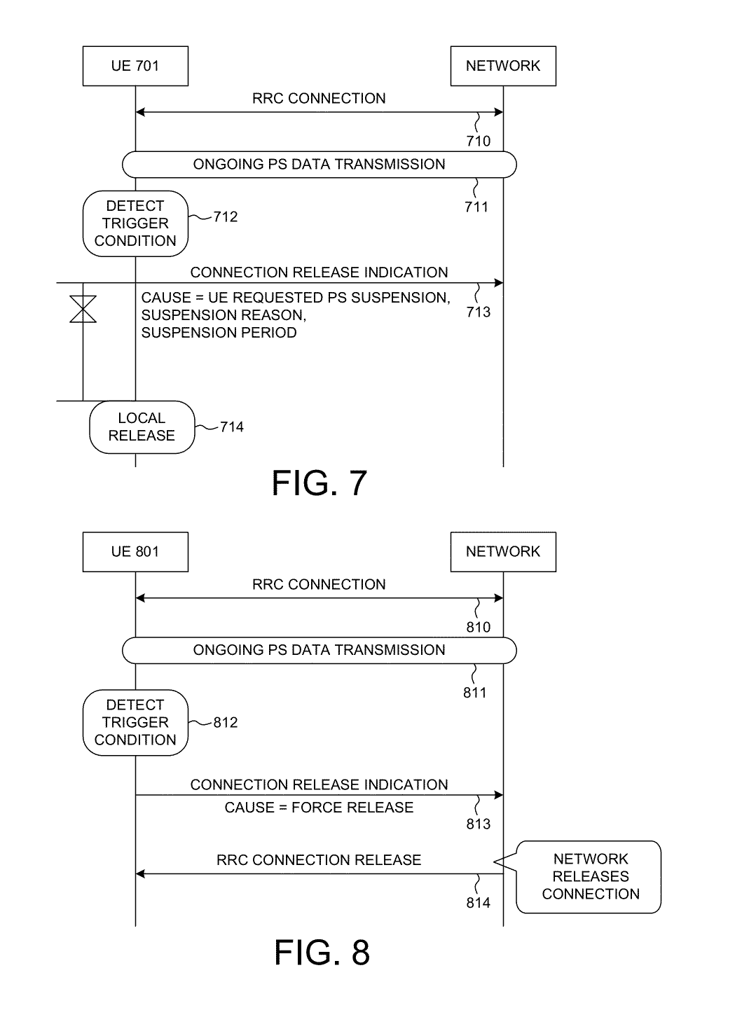

FIG. 7 illustrates one embodiment of UE autonomously release RRC connection upon timer expiry. In step 710, UE 701 establishes an RRC connection with a network. In step 711, UE 701 maintains ongoing PS data transmission with the network. In step 712, UE 701 detects certain trigger condition for suspending the PS data transmission. In step 713, UE 701 sends an SCRI to the network. The SCRI has a cause of UE requested PS suspension, a suspension reason, and a suspension period. According to 3GPP Rel-8 specification, the UE shall not locally release the RRC connection after it has sent the SCRI message. However, in order to prevent the UE from being stuck in waiting the response from the network before switching the RF resources away from receiving radio signals, a timer-based protect mechanism is proposed. In step 713, UE 701 also starts a timer and waits for network response. If the network does not respond to the SCRI before expiry of the timer, then UE 701 performs local release in step 714.

In some scenarios, UE wants to enter IDLE state (i.e., RRC connection released) by sending SCRI, but the network decides to move to CELL_PCH or URA_PCH state. The misinterpretation of the SCRI would still result in local release at the end. A proposed solution is to have an additional flag referred to as “Force Release” in the RRC SCRI message.

FIG. 8 illustrates one embodiment of UE force releasing an RRC connection. In step 810, UE 801 establishes an RRC connection with a network. In step 811, UE 801 maintains ongoing PS data transmission with the network. In step 812, UE 801 detects certain trigger condition for terminating the PS data transmission and releasing the RRC connection. In step 813, UE 801 sends an SCRI to the network. The SCRI has a cause of “Force Release”. In step 814, upon receiving the SCRI with force release cause, the network sends an RRC connection release command to release the RRC connection directly instead of initiating other procedures.

Unexpected collision scenarios may occur when the UE is sending the SCRI message for PS data suspension, e.g., RLC reestablishment and Inter-RAT handover, etc. In order to resolve the unexpected collision, the following solutions are proposed. First, when a reestablishment of the transmitting side of the RLC entity occurs before the successful delivery of the SCRI message has been confirmed by RLC while the SCRI cause is included and is set to “UE Requested PS Data Suspension”, the UE could not retransmit the message using AM RLC in case the new RNC does not support URPDS. Second, when an Inter-RAT handover procedure occurs before the successful delivery of the SCRI message been confirmed by RLC while the SCRI cause is included and set to “UE Requested PS Data Suspension”, the UE could determine whether to abort the signaling connection while in the new RAT. If the UE does not locally release the PS signaling connection after it has sent the SCRI message with SCRI cause set to “UE Requested PS Data Suspension”, the UE could abort the signaling connection while in the new RAT. If not, the UE could maintain the signaling connection. Other collision scenarios could also be handled base on the principle described above. It is noted that the aforementioned solutions are complementary and may be jointly applied for different scenarios.

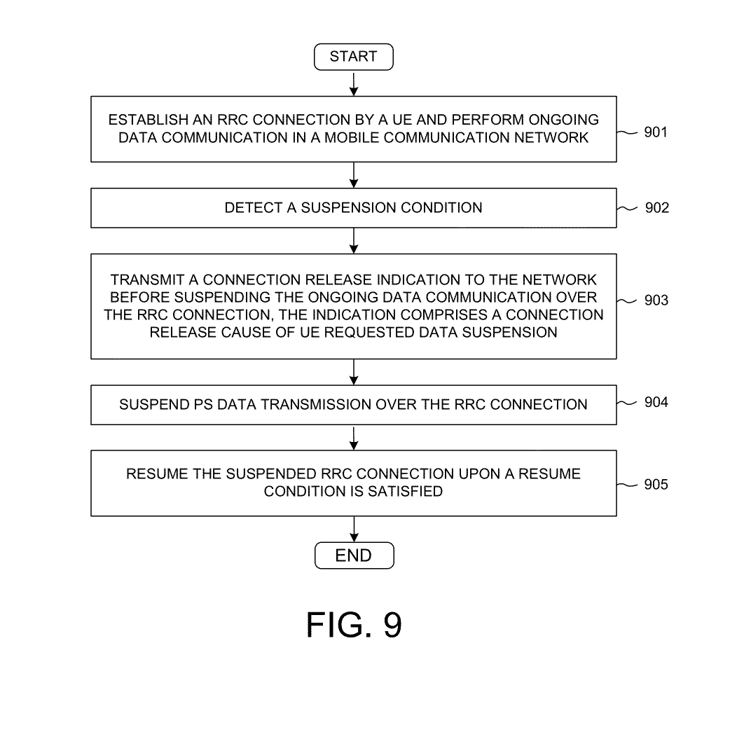

FIG. 9 is a flow chart of a method of suspending and resuming UE data in accordance with one novel aspect. In step 901, a UE establishes an RRC connection and performs ongoing data transmission in a mobile communication network. In step 902, the UE detects a suspension condition. In step 903, the UE transmits a signaling connection release indication (SCRI) message to the network before suspending the ongoing data transmission over the RRC connection. In one embodiment, the SCRI message comprises a connection release cause of UE Requested PS data suspension. The SCRI may further comprises a suspension reason and a suspension period to assist network decision. In step 904, the UE suspends the ongoing data transmission over the RRC connection for the suspension period. In step 905, the UE resumes the suspended RRC connection upon detecting a resume condition. In one embodiment, the UE resumes the previous data communication by applying a cell update procedure without reestablishing the RRC connection and thereby reducing signaling overhead.

Although the present invention has been described in connection with certain specific embodiments for instructional purposes, the present invention is not limited thereto. Accordingly, various modifications, adaptations, and combinations of various features of the described embodiments can be practiced without departing from the scope of the invention as set forth in the claims.

What is claimed is:

1. A method, comprising:
establishing a radio resource control (RRC) connection by a user equipment (UE) and thereby performing ongoing data communication in a mobile communication network;
detecting a suspension condition; and
transmitting a signaling connection release indication to the mobile communication network before suspending the ongoing data communication over the RRC connection, wherein the indication comprises a connection release cause of UE requested data suspension.

2. The method of claim 1, wherein the suspension condition comprises a measurement result of radio signal quality, an error probability of downlink data, a UE mobility level, or a UE battery level below a corresponding threshold.

3. The method of claim 1, wherein the UE is equipped with a first Subscriber Identity Module (SIM) card and a second SIM card, wherein the RRC connection is established over the first SIM card, and wherein the suspension condition comprises the UE detecting an upcoming activity over the second SIM card.

4. The method of claim 1, wherein the connection release indication also comprises a data suspension reason and a data suspension period.

5. The method of claim 1, wherein the UE starts a timer after sending out the indication, and wherein the UE autonomously release the RRC connection upon expiry of the timer.

6. The method of claim 1, wherein the connection release indication contains an indicator on whether the network should release the RRC connection.

7. The method of claim 1, further comprising:
resuming the suspended RRC connection upon a resume condition is satisfied.

8. The method of claim 7, wherein the resume condition is satisfied when a UE mobility level or a UE battery level is above a corresponding threshold, or when a suspension period provided by the UE is over.

9. The method of claim 7, wherein the UE is equipped with a first Subscriber Identity Module (SIM) card and a second SIM card, wherein the RRC connection is established over the first SIM card, and wherein the resume condition comprises a completion of network access with the second SIM card.

10. The method of claim 7, wherein the resuming involves using an RRC cell update procedure, and wherein the UE provides a resume indicator as a cell update cause.

11. A user equipment (UE), comprising:
a radio resource control (RRC) configuration module that establishes an RRC connection and thereby performing ongoing data communication in a mobile communication network;
a condition detection module that detects a suspension condition; and
a radio frequency (RF) module that transmits a signaling connection release indication to the mobile communication network before suspending the ongoing data communication over the RRC connection, wherein the indication comprises a connection release cause of UE requested data suspension.

12. The UE of claim 11, wherein the suspension condition comprises a measurement result of radio signal quality, an error probability of downlink data, a UE mobility level, or a UE battery level below a corresponding threshold.

13. The UE of claim 11, further comprising:
a first Subscriber Identity Module (SIM) card, wherein the RRC connection is established over the first SIM card; and
a second SIM card, wherein the suspension condition comprises the UE detecting an upcoming activity over the second SIM card.

14. The UE of claim 11, wherein the connection release indication also comprises a data suspension reason and a data suspension period.

15. The UE of claim 11, further comprises:
a timer, wherein the UE starts the timer after sending out the indication, and wherein the UE autonomously release the RRC connection upon expiry of the timer.

16. The UE of claim 11, wherein the connection release indication contains an indicator on whether the network should release the RRC connection.

17. The UE of claim 11, wherein the UE resumes the suspended RRC connection upon a resume condition is satisfied.

18. The UE of claim 17, wherein the resume condition is satisfied when a UE mobility level or a UE battery level is above a corresponding threshold, or when a suspension period provided by the UE is over.

19. The UE of claim 17, further comprising:
a first Subscriber Identity Module (SIM) card, wherein the RRC connection is established over the first SIM card; and
a second SIM card, wherein the resume condition comprises a completion of network access with the second SIM card.

20. The UE of claim 17, wherein the resuming involves using an RRC cell update procedure, and wherein the UE provides a resume indicator as a cell update cause.
